(19) United States
(12) Patent Application Publication
(10) Pub. No.: US 2014/0063439 A1
(43) Pub. Date: Mar. 6, 2014

(54) EYEGLASSES WITH REPLACEABLE LENSES

(71) Applicant: Jie-Min Chen, Tainan (TW)

(72) Inventor: Jie-Min Chen, Tainan (TW)

(21) Appl. No.: 13/598,637

(22) Filed: Aug. 30, 2012

(51) Int. Cl. G02C 1/08

(52) U.S. Cl. 351/96

(57) ABSTRACT

Eyeglasses with replaceable lenses include a lens frame, two lenses, two temples jointed pivotally with two ends of the lens frame, and two fastening members. The lens frame has two through holes respectively embedded with the lenses. The through hole has an embedding groove and a blocking projection. The lens frame also is also provided with a combining surface, used to engage with the fastening member, located at two sides respectively and having a notched portion next to the through hole. The fastening member possesses a locking portion with a locking groove at the top and a locking projection located at one side of the bottom for interlocking with the fixing groove. So a user can easily change lenses without utilizing any tool, in accordance with diverse occasions or fondness.

### BACKGROUND OF THE INVENTION

1. Field of the Invention

This invention relates to eyeglasses with replaceable lenses, particularly to one able to make lenses assembled and disassembled with ease, without using any tool.

2. Description of the Prior Art

Commonly, lenses of conventional eyeglasses are directly fixed with frames, not apt to be disassembled from the frames by users. So a user has to prepare multiple eyeglasses, with lenses of nearsightedness or sun protection etc, for diverse occasions or fondness, not only inconvenient to take along, but also costing too much.

### SUMMARY OF THE INVENTION

The object of this invention is to offer eyeglasses with lenses able to be easily assembled or disassembled by users without any tool.

The main characteristics of the invention are a lens frame, two lenses, two temples and two fastening members. The lens frame is provided with two through holes respectively having an embedding groove formed along the edge and a blocking projection built along the inside of the embedding groove. Furthermore, the lens frame includes a combining surface located at two sides respectively and having a notched portion next to the through hole. The combining surface is extended to the top and the bottom edge of the lens frame, with a position projection formed at the top edge and a fixing groove formed in the bottom edge. The lenses are respectively laid in the through holes. The temples are respectively jointed with two ends of the lens frame pivotally. Each of the fastening members is employed to fixedly engage with the combining surface, with a locking portion formed at the top and a locking projection extended horizontally from one side of the bottom. The locking portion is provided with a locking groove formed in the bottom to engage with the position projection. The locking projection is used to engage with the fixing groove. Thus the eyeglasses of the invention can make lenses assembled and disassembled easily without any tool, according to various occasions or fondness of users.

What is to be noted is described as below. The position projection has two inclined surfaces respectively sloping downward from the middle toward the front and the rear side. The fixing groove also has two inclined surfaces respectively sloping downward from the middle toward the front and the rear side. The locking groove of the fastening member has a same shape as the position projection of the lens frame so as to tightly engage with it. And the locking projection of the fastening member has the top shaped the same as the position projection of the lens frame so as to tightly engage with it. So the fastening member can stably combine with the combining surface of the lens frame.

### BRIEF DESCRIPTION OF DRAWINGS

This invention is better understood by referring to the accompanying drawings, wherein:

FIG. 1 is an exploded perspective view of a preferred embodiment of eyeglasses with replaceable lenses in the present invention;

FIG. 2 is an exploded perspective view of the preferred embodiment of eyeglasses with replaceable lenses in the present invention, viewed from another position;

FIG. 3 is a perspective view of the preferred embodiment of eyeglasses with replaceable lenses in the present invention;

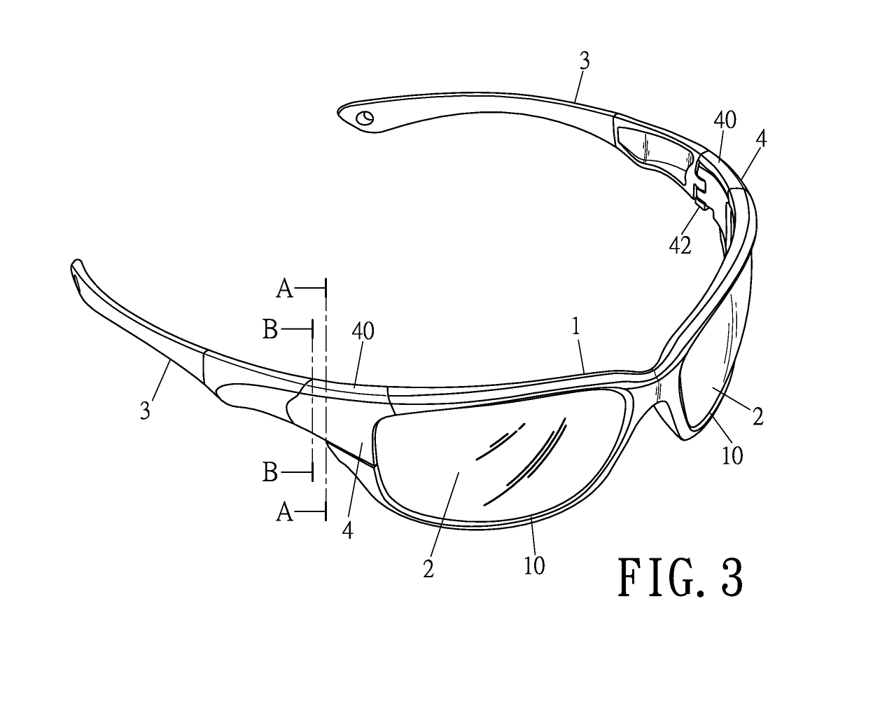

FIG. 4 is a cross-sectional view of A-A line In FIG. 3;

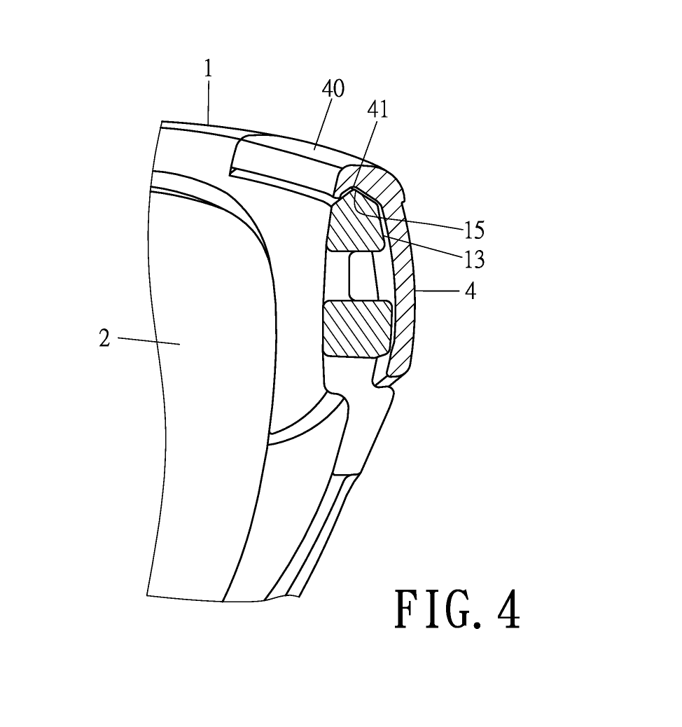

FIG. 5 is a cross-sectional view of B-B line In FIGS. 3; and

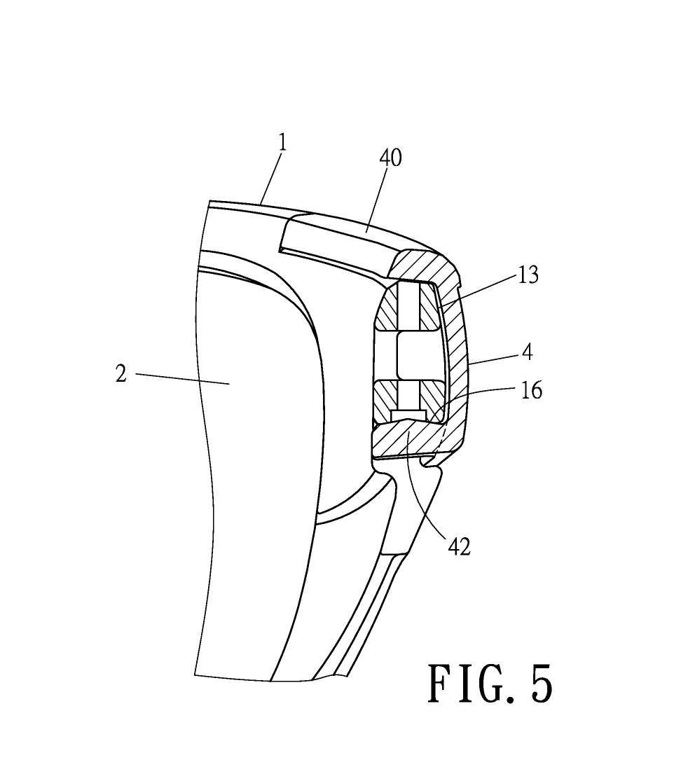

FIG. 6 is top view of a cross section of the invention.

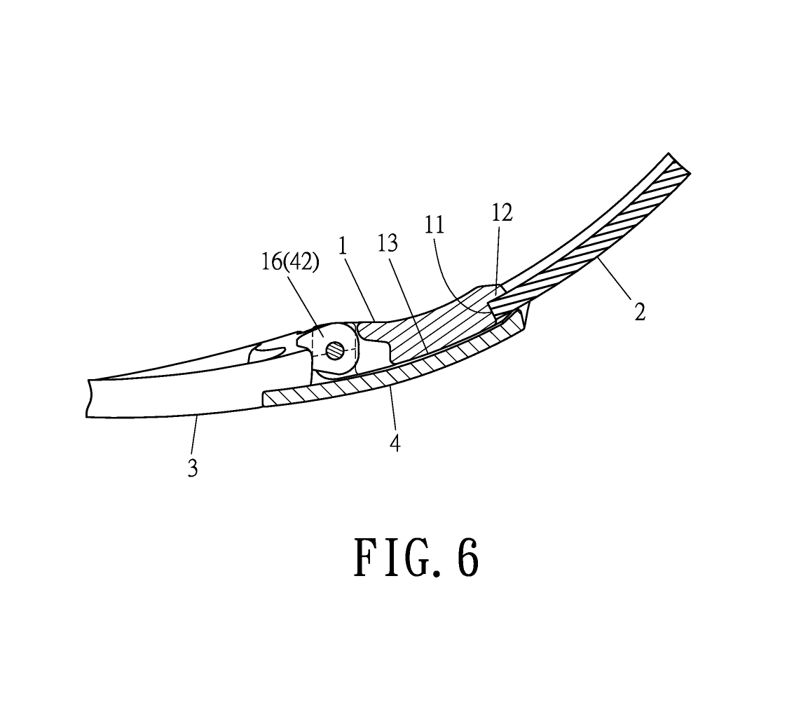

### DETAILED DESCRIPTION OF THE PREFERRED EMBODIMENT

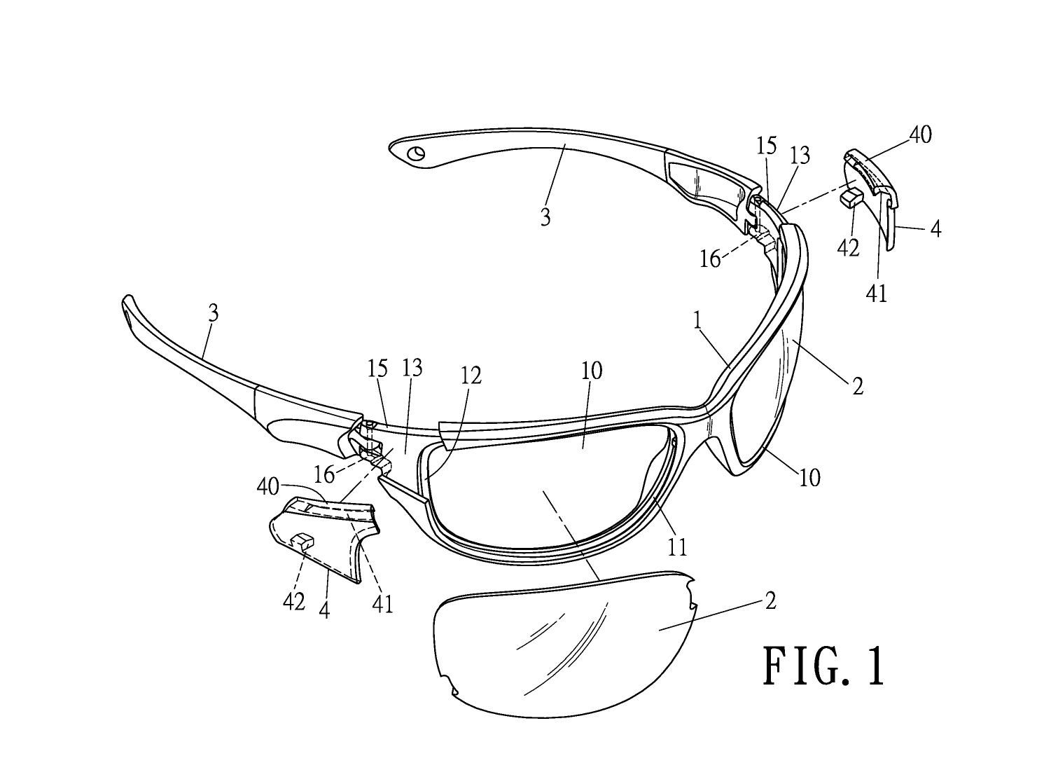

As shown in FIGS. 1˜6, a preferred embodiment of eyeglasses with replaceable lenses in the present invention includes a lens frame 1, two lenses 2, two temples 3, and two fastening members 4.

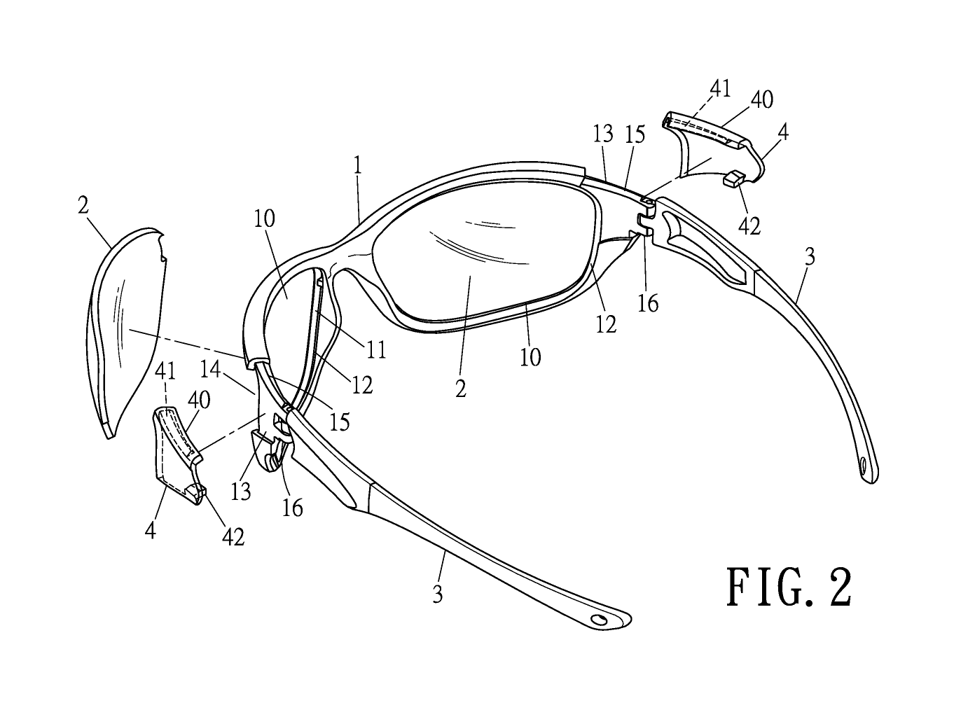

The lens frame 1 is provided with two through holes 10 respectively having an embedding groove 11 formed along the edge and a blocking projection 12 built along the inside of the embedding groove 11. Furthermore, the lens frame 1 is provided with a combining surface 13 located at two sides respectively and having a notched portion 14 next to the through hole 10, as shown in FIG. 2. The combining surface 13 is extended to the top and the bottom edge of the lens frame 1, with a position projection 15 formed at the top edge and a fixing groove 16 formed in the bottom edge. The position projection 15 has two inclined surfaces respectively sloping downward from the middle toward the front and the rear side. The fixing groove 16 also has two inclined surfaces respectively sloping downward from the middle toward the front and the rear side.

The lenses 2 are respectively laid in the through holes 10.

The temples 3 are respectively jointed with two ends of the lens frame 1 pivotally.

Each of the fastening members 4 is employed to fixedly engage with the combining surface 13, with a locking portion 40 formed at the top and a locking projection 42 extended horizontally from one side of the bottom edge. The locking portion 40 is provided with a locking groove 41 formed in the bottom with a same shape as the position projection 15 so as to engage with it. The locking projection 42 is shaped the same as the fixing groove 16 so as to engage with it.

In assembling, as shown in FIGS. 1˜6, with the lenses 2 inserted into the embedding grooves 11 from the notched portion 14 of the engaging surface 13 and restricted by the blocking projections 12, the lenses 2 can be smoothly embedded in the embedding grooves 11 of the lens frame 1 respectively. Next, each of the fastening members 4 is combined with the engaging surface 13 of the lens frame 1, with the locking portion 40 of the fastening member 4 laid on the top of the combining surface 13 to make the position projection 15 of the lens frame 1 interlocked with the locking groove 41 of the fastening member 4 and the fixing groove 16 of the lens frame 1 interlocked with the locking projection 42 of the fastening member 4. So the lenses 2 can be stably positioned in the through holes 10 of the lens frame 1.

In using, as shown in FIGS. 1˜6, if the lens is to be replaced with another one, a user has first to push the fastening member 4 forward to enable the locking portion 40 to move off the position projection 15 and the locking projection 42 to move off the fixing groove 16. Thus the fastening member 4 can be separated from the lens frame 1. By the time, as the lens 2 is not confined by the fastening member 4, it can be easily pulled out of the through hole 10 from the notched portion 14. Then, a new lens 2 can be next assembled in the through hole 10 of the lens frame 1 in accordance with the assembling process mentioned previously. Therefore, as described previously, the eyeglasses of the invention can let a user easily and swiftly change lenses without employing any tool, according to diverse occasions or fondness. And users do not have to spend too much to buy multiple conventional glasses.

While the preferred embodiment of the invention has been described above, it will be recognized and understood that various modifications may be made therein and the appended claims are intended to cover all such modifications that may fall within the spirit and scope of the invention.

What is claimed is:

1. Eyeglasses with replaceable lenses, said eyeglasses comprising:
a lens frame provided with two through holes respectively having an embedding groove formed along an edge and a blocking projection built along an inside of said embedding groove, said lens frame further provided with a combining surface located at two sides respectively, said combining surface having a notched portion formed next to said through hole, said combining surface extended to a top and a bottom edge of said lens frame, a position projection located at a top edge of said combining surface, a fixing groove formed in a bottom edge of said combining surface;
two lenses respectively laid in said through holes;
two temples respectively jointed with two ends of said lens frame pivotally; and
two fastening members used to fixedly engage with said combining surfaces respectively and provided with a locking portion formed in a top and a locking projection extended horizontally from one side of a bottom edge, said locking portion provided with a locking groove formed in a bottom to engage with said position projection of said lens frame, said locking projection employed to engage with said fixing groove of said lens frame.

2. The eyeglasses with replaceable lenses as claimed in claim 1, wherein said position projection has two inclined surfaces respectively sloping downward from a middle toward a front side and a rear side and said fixing groove also has two inclined surfaces respectively sloping downward from a middle toward a front side and a rear side, said locking groove of said fastening member shaped the same as said fixing projection of said lens frame is, said locking projection of said fastening member shaped the same as said fixing groove of said lens frame is.
